(19) United States
(12) Patent Application Publication
(10) Pub. No.: US 2005/0124756 A1
(43) Pub. Date: Jun. 9, 2005

(54) Method of preparing polyvinyl alcohol and optical brightener containing aqueous compositions and particulate blends therefor

(76) Inventors: Gerald D. Miller, Humble, TX (US); Craig E. Mitchell, Highland Village, TX (US)

Correspondence Address: M. Susan SPIERING;c/o Celanese Ltd., IP Legal Dept., IZIP 701, P.O. Box 428, Bishop, TX, 78343, US

(21) Appl. No.: 10/869,120

(22) Filed: Jun. 16, 2004

Related U.S. Application Data
(63) Continuation-in-part of application No. 10/731,495, filed on Dec. 9, 2003.

(51) Int. Cl. C08K 3/00

(52) U.S. Cl. 524/557

(57) ABSTRACT

The present invention relates generally to an improved method of preparing aqueous coating compositions including an optical brightener and a polyvinyl alcohol resin, the improvement being directed to cooking a slurry to dissolve the polyvinyl alcohol resin subsequent to the addition of optical brightener and polyvinyl alcohol resin to the slurry at a temperature above about 160° F. for at least about 5 minutes. The invention enables preparation with lower water content without compromising brightness and color. Particularly preferred is the addition of dry resin and/or dry brightener to provide high solids mixtures. Another aspect of the invention is a dry, particulate blend of brightener and PVOH resin.

### CROSS REFERENCE TO RELATED APPLICATION

This non-provisional application is a continuation-in-part of U.S. patent application Ser. No. 10/731,495 entitled “Polyvinyl Alcohol and Optical Brightener Concentrate”, filed on Dec. 9, 2003, the priority of which is claimed.

### TECHNICAL FIELD

The present invention relates to a novel methodology and products for preparing mixtures of polyvinyl alcohol (PVOH) and optical brighteners having high solids for easier drying and faster production rates. The coatings made with the compositions are especially suited for high quality coated papers.

### BACKGROUND OF THE INVENTION

Paper coating compositions, or coating colors, are used by the paper industry to impart the desired moisture resistance, physical properties and appearance to certain grades of finished paper. Generally, the coating composition is an aqueous dispersion consisting mainly of mineral pigments like clay, calcium carbonate or titanium dioxide, and pigment binders of natural protein, starch or synthetic polymer emulsions. Styrene-butadienes and polyvinyl acetates are examples of such synthetic emulsion binders. Coating compositions may also contain additives, such as thickeners, humectants and lubricants.

Coating compositions are usually applied to a continuous web of material by high speed coating machines, such as blade coaters, air knife coaters, rod coaters and roll coaters. It is advantageous to use faster coaters to increase productivity and to use higher solids coating compositions to decrease drying costs and improve binder distribution.

High brightness coated grades of paper typically include optical brighteners (OBs). Optical brighteners generally operate by way of absorbing ultra-violet radiation and then immediately re-admitting in the visible blue-white range. Examples of optical brighteners include UVITEX® and TINOPAL® from Ciba Specialty Chemicals, BLANKOPHOR® from Bayer and HOSTALUX® and LEUCOPHOR® from Clariant. Most OBs have active ingredients that belong to the stilbene class of compounds as shown in Structures A, B, and C: 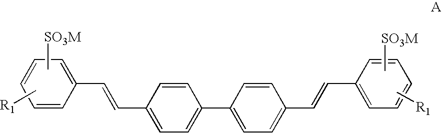
where M can be H, an alkali metal, ammonium or magnesium and R₁ represents hydrogen, C₁-C₅ alkyl, C₁-C₅ alkoxy or halogen.

Such compounds also include those of Structure B. below:

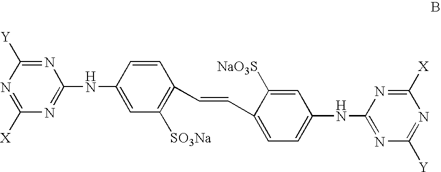

U.S. Pat. No. 5,057,570 to Air Products and Chemicals, Oct. 15, 1991, describes a process for producing paper coating compositions using partially hydrolyzed, low molecular weight polyvinyl alcohol. The advantage of using this polymer is that no external heating is required and that it can be added as a dry solid to the aqueous pigment dispersion. This can be accomplished under high shear stirring, typically at speeds of 1500 rpm for 5 minutes at room temperature.

U.S. Pat. No. 5,830,241 to Ciba Specialty Chemicals, Nov. 3, 1998, describes a liquid preparation of a fluorescent whitening agent, low MW polyethylene glycol, water and auxiliary compounds. The polyethylene glycol is in liquid form and functions as the non-volatile solvent to stabilize liquid preparations of the agent when stored at elevated temperatures (50° C.). The low MW of the polyethylene glycol has a low viscosity, which results in a pumpable solution. A typical structure of the fluorescent whitening agent is: 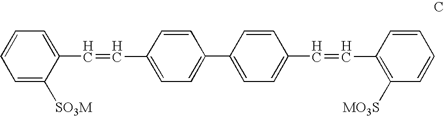
where M is H, an alkali metal, ammonium or magnesium and polyvinyl alcohol (PVOH) is a preferred carrier.

U.S. Pat. No. 6,521,701 to Coatex S. A. S., Feb. 18, 2003, describes a stable aqueous liquid polymer composition containing polyvinyl alcohol in combination with a homopolymer or copolymer of carboxylic acid in completely acid form. This combination of polymers has been found to optimize the function of water retention, which activates optical brighteners, and which controls the viscosity of coating colors. This is all accomplished without degrading the water-retention property.

U.S. Pat. No. 6,620,294 to Ciba Specialty Chemicals, Sep. 16, 2003, describes stable aqueous solutions of fluorescent whitening agents that contain polyvinyl alcohol. The solutions can be prepared by mixing a moist press filter cake or dry powder of a fluorescent whitening agent with an aqueous solution of a modified or unmodified polyvinyl alcohol, with or without optional additives, and heating and mixing until a homogeneous distribution is obtained.

While OBs alone work well, the inclusion of PVOH boosts their performance. In some cases, paper makers use standard PVOH grades purchased in dry form which are then prepared for use by cooking in conventional batch vessels. A disadvantage of this methodology is that the water used in the PVOH cook dilutes the coating formulation by a significant amount, which can negatively impact production rates. In addition, there is a cost to the mill for cooking PVOH; and, in many cases, that cost is compounded with problems because of inadequate equipment or poorly trained operators. Generally, PVOH is supplied to papermakers in a variety of forms: 1) dry resin that is cooked in water by the customer at 20% to 30% solids, the advantage being that less costly grades of PVOH can be used, the drawbacks being noted above; 2) PVOH that has been pre-cooked and delivered to the customer at 15% to 25% solids, which is costly to the papermaker as it involves shipping mostly water; and 3) dry, fine particle size partially hydrolyzed grades that are added dry to the pigmented formulations. These latter products are relatively expensive ground material, but are convenient if cooking is not an option. See U.S. Pat. No. 5,057,570. See also U.S. Pat. No. 6,620,294 where there are described solutions of PVOH and optical brighteners prepared by thoroughly mixing the moist press cake or the dry powder of a fluorescent whitening agent with an aqueous solution of PVOH and heating.

It has been found in accordance with the present invention that optical brighteners and relatively inexpensive grades of PVOH can both be directly incorporated into water to form a slurry, followed by cooking the mixture to solubilize the materials, to produce an aqueous brightener composition; providing product and manufacturing options not previously possible. It is possible to use dry blends of PVOH resin and powdered optical brightener or to use either component in dry form.

### SUMMARY OF THE INVENTION

The present invention relates generally to improved methods of preparing aqueous compositions including an optical brightener and a polyvinyl alcohol resin, the improvement being directed to cooking a PVOH containing slurry to dissolve the polyvinyl alcohol resin subsequent to the addition of optical brightener and polyvinyl alcohol resin at a temperature above about 160° F. for at least about 5 minutes. The invention enables preparation of lower water content formulations without compromising brightness and color. Particularly preferred is the addition of dry resin and/or dry brightener to provide high solids mixtures. Another aspect of the invention is a method of providing PVOH and optical brightener to a color coat composition without external heating. Still another aspect of the invention is a dry, particulate blend of brightener and PVOH resin, the details of which are described hereinafter.

### BRIEF DESCRIPTION OF FIGURES

The invention is illustrated in connection with the various Figures, wherein:

FIGS. 1-4 are histograms presenting the Hunter Color data of the coatings of Examples 11, 12 and Comparative Examples F, G; and

FIGS. 5-8 are histograms presenting the Hunter Color data of the coatings of Examples 17, 18 and Comparative Examples H-N.

### DETAILED DESCRIPTION OF THE INVENTION

The present invention is described in detail below with reference to numerous embodiments for purposes of illustration only. Modifications within the spirit and scope of the invention, set forth in the appended claims, will be readily apparent to those of skill in the art. In some cases, the optical brightener is added to an aqueous composition such as a PVOH slurry in substantially dry form; in other embodiments, the polyvinyl alcohol resin is added to an aqueous optical brightener solution in substantially dry form; while in still other embodiments both the optical brightener and the polyvinyl alcohol resin are added to water in substantially dry form, to form a slurry.

In some preferred applications of the inventive process, the slurry is cooked at a temperature of at least about 175° F. for at least 10 minutes subsequent to the addition of optical brightener and polyvinyl alcohol resin. Typically, the slurry is cooked at a temperature above about 160° F. for at least bout 10 minutes subsequent to the addition of polyvinyl alcohol resin and optical brightener and polyvinyl alcohol resin; usually the slurry is cooked at a temperature above about 160° F. for at least bout 20 minutes subsequent to the addition of polyvinyl alcohol resin and optical brightener and polyvinyl alcohol resin. In many cases, the slurry is cooked at a temperature of from about 175° F. to about 210° F. for a time of from about 10 minutes to about 120 minutes subsequent to the addition of polyvinyl alcohol resin and optical brightener. Perhaps most preferably, the aqueous composition is cooked at a temperature of from about 185° F. to about 205° F. for a time of from about 20 minutes to about 60 minutes subsequent to the addition of polyvinyl alcohol resin and optical brightener.

Suitable polyvinyl alcohol resins have a viscosity of from about 2 cps to about 40 cps; typically, the polyvinyl alcohol resin has a viscosity of from about 2 cps to about 8 cps; more generally, the polyvinyl alcohol resin has a viscosity of from about 3 cps to about 30 cps. From about 3 cps to about 8 cps is one preferred range as is a viscosity of from about 3 cps to about 7 cps. Preferably, the polyvinyl alcohol resins are hydrolyzed on a mole percent basis of from about 80 to about 99.5 percent; typically, the polyvinyl alcohol resin is hydrolyzed on a mole percent basis of from about 85 percent to about 90 percent and has a degree of polymerization of from about 50 to about 2000. Typically, the polyvinyl alcohol resin has a degree of polymerization of from about 50 to about 300.

In some preferred embodiments, the optical brightener active ingredient comprises a stilbene compound and may be a sulfonated stilbene compound, such as a tetrasulfonated stilbene compound or a hexasulfonated stilbene compound. One preferred class is wherein the optical brightener active ingredient comprises a stilbene compound of the formula:

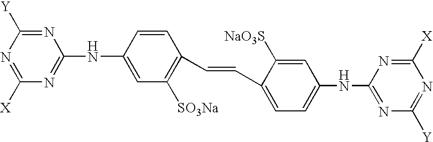

wherein X and Y are independently selected from the moieties indicated below:

| | Disulfo | Tetrasulfo 1 | Tetrasulfo 2 | Hexasulfo |
|---|---|---|---|---|
| X | 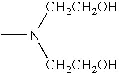 | 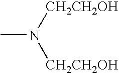 | 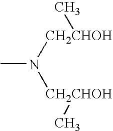 | 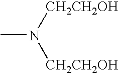 |
| Y | 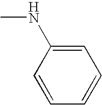 | 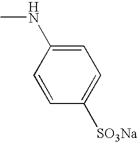 | 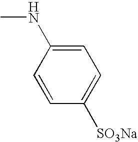 | 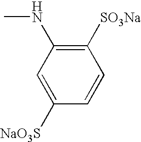 |

In another aspect of the invention there is provided a method of preparing an optical brightener/PVOH aqueous concentrate comprising the sequential steps of: preparing an aqueous PVOH slurry; adding a dry, particulate optical brightener to the aqueous PVOH slurry; and cooking the slurry containing PVOH and optical brightener to dissolve the PVOH resin for at least 5 minutes at a temperature of above about 160° F.

In yet another aspect of the invention there is provided a method of preparing an optical brightener/PVOH aqueous concentrate comprising the sequential steps of: providing a dry powder optical brightener; providing a dry polyvinyl alcohol resin; dry blending said polyvinyl alcohol resin with said optical brightener in an amount of about 1 part of dry polyvinyl alcohol resin per 0.05 to 1 part of optical brightener; admixing said dry blend with water to provide a nascent aqueous concentrate of polyvinyl alcohol resin and optical brightener; and cooking the aqueous concentrate to dissolve the solids at an elevated temperature for a time sufficient to dissolve substantially all of the polyvinyl alcohol resin and optical brightener so as to provide a cooked brightener/polyvinyl alcohol concentrate including water, polyvinyl alcohol resin, optical brightener, and optionally minor amounts of auxiliaries.

Still another feature is a dry, particulate blend of a polyvinyl alcohol resin and an optical brightener wherein the polyvinyl alcohol resin is 85-90 mol % hydrolyzed and has a degree of polymerization ranging from about 50 to about 600. The polyvinyl alcohol resin is preferably 85-90 mol % hydrolyzed and has a degree of polymerization ranging from about 185 to about 235. Still more preferably, the polyvinyl alcohol resin is 87-89 mole % hydrolyzed and has a viscosity of from about 2 cps to about 8 cps.

A preferred “no cook” process for making a color coat composition includes: (a) preparing a pigment dispersion; (b) preparing a dry blend of polyvinyl alcohol resin and optical brightener, wherein the polyvinyl alcohol resin is from about 85 mol % to about 90 mol % hydrolyzed and has a fine particle size, such that at least about 99% of the particles pass an 80 mesh sieve; (c) adding the dry blend of polyvinyl alcohol resin and optical brightener to the pigment dispersion; and (d) applying shear to the pigment dispersion containing the polyvinyl alcohol and optical brightener so as to mix the dispersion and dissolve both the optical brightener and polyvinyl alcohol resin without external heating.

There is still further provided a method of preparing an optical brightener/PVOH aqueous concentrate by way of the sequential steps of: (a) providing an aqueous brightener composition including water and optical brightener active ingredient, wherein the optical brightener active ingredient is present in the aqueous brightener composition typically in an amount of from about 10% to about 25%; (b) admixing a polyvinyl alcohol resin with said aqueous optical brightener composition in an amount of about 1 part of dry polyvinyl alcohol resin per 0.25 to 10 wet parts of aqueous brightener composition to provide a nascent aqueous concentrate of polyvinyl alcohol resin and optical brightener; and (c) cooking the aqueous concentrate to dissolve substantially all of the PVOH resin, usually at a temperature of from about 175° F. to about 210° F. generally for a time of from about 10 minutes to about 120 minutes to provide a cooked brightener/polyvinyl alcohol concentrate consisting essentially of water, polyvinyl alcohol resin and optical brightener active ingredient. Typically, the polyvinyl alcohol resin is admixed in an amount of about 1 part of dry polyvinyl alcohol resin per 0.5 to 10 wet parts of aqueous brightener composition.

The optical brightener active ingredient is usually present in the aqueous brightener composition in an amount of from about 12% to about 20% and the optical brightener/PVOH aqueous concentrate typically has a solids content of from about 20% to about 75% based on the water, polyvinyl alcohol and optical brightener active ingredient content of the concentrate. More typically, the polyvinyl alcohol is admixed with the aqueous optical brightener composition in an amount of from about 15% to about 55% PVOH based on the combined weight of the water, the optical brightener active ingredient and polyvinyl alcohol resin, the concentrate having a solids content of from about 30 to about 60%. Likewise, the aqueous concentrate is usually cooked to dissolve the solids at a temperature of from about 185° F. to about 205° F. for a time of from about 20 minutes to about 60 minutes. Suitable polyvinyl alcohol resins have viscosities of from about 2 or 3 cps to about 30 or 40 cps; most preferably in some cases the polyvinyl alcohol resin has a viscosity of from about 2 or 3 cps to about 7 or 8 cps or from about 3 cps to about 4 cps.

The polyvinyl alcohol resin is generally hydrolyzed on a mole percent basis of from about 80 to about 99.5 percent; typically, the polyvinyl alcohol resin is hydrolyzed on a mole percent basis of from about 85 percent to about 90 percent and has a degree of polymerization of from about 50 to about 2000. A degree of polymerization of from about 50 to about 1700 is more preferred as is a degree of polymerization of from about 50 to about 300.

Most preferably, the polyvinyl alcohol resin is added to the aqueous brightener composition in substantially dry form; and sometimes the step of diluting the aqueous concentrate is expedient, depending on processing characteristics sought. So also, the concentrate can be directly applied to a paper substrate in a size press, if so desired.

The method may further include the step of adding polyethylene glycol to the aqueous concentrate and wherein the polyethylene glycol is added to the aqueous brightener composition or to the nascent or cooked aqueous concentrate in an amount of from about 0.5 to about 2 parts by weight per dry part of polyvinyl alcohol resin.

One preferred method of preparing a color coat composition includes the sequential steps of:
(a) providing an aqueous brightener composition consisting essentially of water and optical brightener active ingredient, wherein the optical brightener active ingredient is present in the aqueous brightener composition in an amount of from about 10 to about 25%;
(b) admixing a polyvinyl alcohol resin with said aqueous optical brightener composition in an amount of about 1 part of dry polyvinyl alcohol resin per 0.25 to 10 wet parts of aqueous brightener comlposition to provide a nascent aqueous concentrate of polyvinyl alcohol resin and optical brightener;
(c) cooking the aqueous concentrate to dissolve the solids at a temperature of from about 175° F. to about 210° F. for a time of from about 10 minutes to about 120 minutes to provide a cooked brightener/polyvinyl alcohol concentrate consisting essentially of water, polyvinyl alcohol resin and optical brightener compounds; and
(d) admixing the cooked concentrate with an aqueous dispersion comprising color pigment and a binder resin to produce the color coat composition. Typically, the polyvinyl alcohol resin is admixed in an amount of about 1 part of dry polyvinyl alcohol resin per 0.5 to 10 wet parts of aqueous brightener composition.

The method may further include the step of applying the color coat to paper.

An optical brightener aqueous concentrate consists essentially of water, an optical brightener active ingredient and a polyvinyl alcohol resin having a viscosity of from about 2 cps to about 4 cps, wherein the aqueous concentrate is from about 20 to about 75% solids, and the polyvinyl alcohol resin is hydrolyzed from about 80 to about 90 percent on a molar basis. The concentrate optionally includes auxiliaries such as dispersing agents, protective colloids, solvents for the colloids, and/or antifreezes, sequestering agents and the like, none of which change the basic and novel characteristics of the concentrates. When referring to the optical brightener/PVOH aqueous concentrate, auxiliaries also include minor amounts of binder, plasticizer, filler, water retention aids such as carboxymethyl cellulose and so forth. Typically, the polyvinyl alcohol resin has a viscosity of from 3 cps to 4 cps and the aqueous concentrate is from about 25 to about 65 percent solids. The optical brightener concentrate further comprises polyethylene glycol in some cases and the optical brightener active ingredient comprises a stilbene compound. The stilbene compound may be a sulfonated stilbene compound may be a stilbene compound as noted above.

In still yet another aspect of the invention, an optical brightener aqueous concentrate consists essentially of water, an optical brightener active ingredient, polyethylene glycol and a polyvinyl alcohol resin has a viscosity of from about 2 cps to about 4 cps, wherein the aqueous concentrate is from about 20 to about 75% solids, and wherein the polyvinyl alcohol resin is hydrolyzed from about 80 to about 90 percent on a molar basis.

As used herein, terminology has its ordinary meaning unless a more specific or more general meaning is given below or is clear from the context.

%, percent or per cent means weight percent unless mole percent is specified.

“Cps” means centipoise.

“Minor amount” means less than 50% by weight exclusive of water content.

“PVOH” means polyvinyl alcohol resins which are typically prepared from polyvinyl acetate resins by saponification thereof which is well known in the art. PVOH resins are derived from homopolymers of vinyl acetate as well as copolymers of vinyl acetate with other ethylenically unsaturated monomers and may include cationic sites if so desired. Preferably, the resins are 95 mole percent or more vinyl acetate derived. Suitable resins, available from Celanese, Inc. include:

TABLE 1
Polyvinyl Alcohol Resins

| Grade | % Hydrolysis, | Viscosity, cps¹ | pH |
|---|---|---|---|
| Celvol 125 | 99.3+ | 28-32 | 5.5-7.5 |
| Celvol 165 | 99.3+ | 62-72 | 5.5-7.5 |

Fully Hydrolyzed

| | | | |
|---|---|---|---|
| Celvol 103 | 98.0-98.8 | 3.5-4.5 | 5.0-7.0 |
| Celvol 305 | 98.0-98.8 | 4.5-5.5 | 5.0-7.0 |
| Celvol 107 | 98.0-98.8 | 5.5-6.6 | 5.0-7.0 |
| Celvol 310 | 98.0-98.8 | 9.0-11.0 | 5.0-7.0 |
| Celvol 325 | 98.0-98.8 | 28.0-32.0 | 5.0-7.0 |
| Celvol 350 | 98.0-98.8 | 62-72 | 5.0-7.0 |

Intermediate Hydrolyzed

| | | | |
|---|---|---|---|
| Celvol 418 | 91.0-93.0 | 14.5-19.5 | 4.5-7.0 |
| Celvol 425 | 95.5-96.5 | 27-31 | 4.5-6.5 |

Partially Hydrolyzed

| | | | |
|---|---|---|---|
| Celvol 502 | 87.0-89.0 | 3.0-3.7 | 4.5-6.5 |
| Celvol 203 | 87.0-89.0 | 3.5-4.5 | 4.5-6.5 |
| Celvol 205 | 87.0-89.0 | 5.2-6.2 | 4.5-6.5 |
| Celvol 513 | 86.0-89.0 | 13-15 | 4.5-6.5 |
| Celvol 523 | 87.0-89.0 | 23-27 | 4.0-6.0 |
| Celvol 540 | 87.0-89.0 | 45-55 | 4.0-6.0 |

¹4% aqueous solution, 20° C.

When the viscosity of a polyvinyl alcohol resin is specified, the viscosity is the viscosity of a 4% aqueous (wt/wt) solution of the PVOH, at 20° C.

Suitably, CIE L*, a*, b* and brightness values are used to characterize coated products prepared with coating formulations of the invention. L*, a*, and b* values may be suitably measured using test methods such as TAPPI T 524 om-02, TAPPI T 527 om-02, or similar methods. TAPPI T 524 incorporates 45° directional illumination and perpendicular (0°) observation geometry. TAPPI T 527 incorporates diffuse illumination and 0° observation geometry. L* is a measure of lightness increasing from 0 for black to 100 for perfect white; a* indicates redness when positive and green when negative; b* indicates yellowness when positive and blueness when negative. Note that (GE) brightness is measured in accordance with TAPPI T 452 om-02. TAPPI 452 incorporates 45° illumination and 0° observation geometry. Unless otherwise indicated, Brightness values are reported with ultra-violet (UV) radiation. To calculate Brightness without UV, the UV component is subtracted from the UV Brightness.

“Slurry” refers to an aqueous composition including undissolved solids.

A “color coat composition” includes an aqueous pigment dispersion and optionally a synthetic binder resin. Typical binder resins are styrene-butadiene latexes or polyvinyl acetate emulsions. Polyvinyl alcohol resins are binder resins, preferably used as a co-binder.

The aqueous pigment dispersion with which the inventive concentrates are combined typically consists of clay or calcium carbonate or mixtures of the two at solids levels ranging from about 70 to 76%. In general, at least a portion of the pigment comprises calcium carbonate and for the clay portion, any of the clays customarily used for the paper coating, such as the hydrous aluminum silicates of the kaolin group clays, hydrated silica clays and the like can be used. In addition to the calcium carbonate and clay, there may be added other paper pigments, such as, for example titanium dioxide, blanc fixe (“barium sulfate”), lithopone, zinc sulfide, or other coating pigments, including plastics, for example, polystyrene, in various ratios, for example, up to 50 wt. %., preferably up to 35 wt. % based on calcium carbonate and clay. Additionally, the composition may also contain other additives, such as zinc oxide and/or a small amount of a dispersing or stabilizing agent, such as tetra-sodium pyrophosphate.

Suitable low molecular weight, partially or mostly hydrolyzed polyvinyl alcohols for the practice of this invention can be 70-99.5%, preferably 85-90, and most preferably 87-89, mole % hydrolyzed and have a degree of polymerization (DP) ranging from 50-600, preferably 185 to 255. Another means for assessing the DP of the polyvinyl alcohol is its viscosity as a 4 wt. % aqueous solution at 20° C. Suitable polyvinyl alcohols have a viscosity ranging from about 2 to 30 cps, preferably 3-4 cp. Such polyvinyl alcohols can be prepared by synthesis and saponification techniques well known to those skilled in the art of manufacturing polyvinyl alcohol. A preferred polyvinyl alcohol having a viscosity of about 4 cp and an 87-89 mole % hydrolysis is marketed by Celanese under the trademark CELVOL® 203. Another preferred polyvinyl alcohol is CELVOL® 502, which has a viscosity of about 3 cp. The polyvinyl alcohol is incorporated as a dry powder with the dry OB. The optical brightener active ingredients are of the stilbene class noted above and have the general structure of structures A, B and C. Suitable stilbenes are disclosed in U.S. Pat. No. 6,620,294 and U.S. Pat. No. 5,830,241, the disclosures of which are incorporated by reference. Commercially available optical brighteners include UVITEX® and TINOPAL® from Ciba Specialty Chemicals, BLANKOPHOR® from Bayer and HOSTALUX®, LEUCOPHOR® from Clariant and PARAWHITE® from Paramount.

The high solids aqueous pigment dispersion containing the polyvinyl alcohol as a co-binder can then be used to prepare paper coating compositions comprising (parts by wt): 100 parts pigment containing clay and/or calcium carbonate and 0 to 35 parts secondary pigment; 0.01 to 0.5 parts dispersing or stabilizing agent; 1 to 30 parts polymer binder emulsion (solids basis); 0.1 to 10 parts, preferably 0.5 to 2 parts, polyvinyl alcohol co-binder; 0.1 to 20 parts other co-binders; 0 to 0.2 parts defoamer, and sufficient water to provide the desired level of solids, usually about 45 to 70 wt. %, preferably 60 to 70 wt. % or more for high solids paper coating compositions.

The coating compositions produced may be applied to fibrous paper webs using any of the conventional coating devices, including trailing blade coaters, air-knife coaters roll coaters, and the like.

The appearance of the resulting cooked blend, other than viscosity, does not change.

Because of the viscosity, sometimes dilutions are desirable. However, at 27% blends solids, the papermaker has the benefit of a relatively high solids solution.

For all the formulations discussed below, pigments are primarily calcium carbonate and clay, but may include titanium dioxide. There are optionally other ingredients such as carboxymethyl cellulose, lubricants, dyes, defoamers, as is well known in the art. Units are expressed as dry pts/100 pigment, except for the OB. In terms of raw materials, pigments are delivered in dry or in water pre-dispersed form that may range from about 70% to 76% solids. Styrene butadiene latexes are delivered at about 50% solids. PVOH may be delivered in solid form to be cooked into solution prior to using, or in liquid form at 15% to 30% solids. OBs for coating are delivered in liquid form at about 17% active ingredient, and are most preferably of the tetra or hexa sulfonated variety.

Blends and coatings include 1/1, 2/1, 3.75/1 and 5/1 wet OB (Ciba's TINOPAL® PT, a tetrasulfonated form)/dry PVOH (CELVOL® 203).

Normal operations in paper mills call for PVOH and OBs to be added each as liquids into the formulating tank. However, the invention takes advantage of the water in the OB through the addition of dry PVOH to 100 pts of OB slurry in a vessel while stirring sufficiently to disperse the PVOH particles in a uniform fashion. The contents are then heated to 185° F. to 205° F., depending upon the grade of PVOH used, preferably by steam heated water bath. The temperature of the blend is held at temperature for 30 minutes, at which time the PVOH will be totally solubilized and the blend may be either cooled or used hot. The solids levels above are considered maximum since no dilutions have taken place.

As shown below, in the various Examples, the method of this invention results in paper coating formulations with higher total coating solids than can be achieved by conventional methods. Using current methodology, for the ratios of OB/PVOH indicated and utilizing standard pigment dispersions of either 70% or 76% solids, the maximum coating solids that can be achieved, by adding the OB and PVOH (25% solids) each as liquids, range from 64.4% to 70.0% and 69.0% to 70.2% (using 30% solids PVOH).

In contrast, the method of this invention adds dry PVOH to an OB solution. After the dry PVOH is added, the formulation is heated for 30 minutes at temperatures ranging from 185° F. to about 205° F. to completely solubilize the PVOH. This solution is then added to either a 70% or 76% solids pigment dispersion to achieve the final coating solids shown below.

Color coat formulations are sometimes expressed in dry parts and wet parts per 100 parts dry pigment. A typical or “standard” coating formulation is as follows:

100 parts dry pigment@70% solids=142.9 wet parts

14 dry parts latex@50% solids=28 wet parts

0.34 dry parts@17% Active Ingredient=2 wet parts

1 dry part PVOH@ 25% solids=4 wet parts

Table 2 below shows solids content for a standard formulation with 2/1 wet parts/dry parts OB/PVOH ratio per 100 parts of pigment by way of conventional formulation techniques.

TABLE 2
Sample Calculation

| Dry Parts | Ingredient | Wet parts |
|---|---|---|
| 100 | Pigment at 70% solids | 142.9 |
| 14 | Latex at 50% solids | 28.0 |
| 0.34 | OB at 17% solids | 2.0 |
| 1.0 | PVOH at 25% solids | 4 |
| 115.34 | TOTALS | 176.9 |
| | Solids Percentage = 65.2% | |

With the invention, carrier water from the PVOH resin composition is eliminated and the same “dry” formulation (2/1 wet OB/dry PVOH) has the composition shown in Table 3, with a solids advantage of 1.1% overall.

TABLE 3
Sample Calculation

| Dry Parts | Ingredient | Wet parts |
|---|---|---|
| 100 | Pigment at 70% solids | 142.9 |
| 14 | Latex at 50% solids | 28.0 |
| 1.34 | OB/PVOH at 44.7% solids* | 2.99 |
| 115.34 | TOTALS | 173.89 |
| | Percentage = 66.3% | |

*The foregoing uses the 44.7% solids solution shown in Example Series 2 with the 70% pigment dispersion.

Following are numerous additional examples and comparative examples showing the solids advantages realized with the invention as opposed to conventional formulation techniques. These examples use the standard components specified above, varying wet OB/dry PVOH ratios and pigment solids content.

1/1 Wet OB/Dry PVOH

### COMPARATIVE EXAMPLE SERIES A

The color coat is formulated with either 70% or 76% solids pigment dispersions and 25% or 30% PVOH solution. Using the standard methodology of mixing liquid OB (usually 17% solids) with liquid PVOH, and adding to the pigment dispersion, the solids that can be achieved is shown below in Table 4:

TABLE 4
1/1 Wet OB/Dry PVOH

| | Current Methodology |
|---|---|
| % Solids | Ingredients Added Separately |
| Pigment | Coating Solids, % |
| 70% | 65.5% using 25% solids PVOH |
| 76% | 70.0% using 25% solids PVOH |
| 76% | 70.2% using 30% solids PVOH |

### EXAMPLE SERIES 1

In contrast to the above, the invention utilizes a solution prepared by adding dry PVOH to a 17% solution of OB to achieve the following concentrations. In this case, the OB/PVOH solution is prepared as follows:

83 pts water and 17 pts active ingredient OB+100 pts dry PVOH. Dry solids=(100+17)/200=58.5%; cooked as noted above.

This solution is subsequently added to the pigment dispersion to achieve the results shown in Table 5:

TABLE 5
1/1 Wet OB/Dry PVOH
Invention Pre-Blend
One Addition Process
No Dilution of Blend

| % Solids | Coating | % Solids |
|---|---|---|
| Pigment | % Solids | Advantage |
| 70 | 66.6 | +1.1 |
| 76 | 71.2 | +1.2 |
| 76 | 71.2 | +1.0 |

As can be seen from the above table, there is a distinct solids advantage over current practice.

2/1 wet OB/Dry PVOH

### COMPARATIVE EXAMPLE SERIES B

Following the procedures outlined above, the maximum solids attainable using conventional procedures is shown in Table 6:

TABLE 6
2/1 Wet OB/Dry PVOH

| | Current Methodology |
|---|---|
| % Solids | Ingredients Added Separately |
| Pigment | Coating Solids, % |
| 70% | 65.2% using 25% solids PVOH |
| 76% | 69.6% using 25% solids PVOH |
| 76% | 69.9% using 30% solids PVOH |

### EXAMPLE SERIES 2

Dry PVOH is mixed with 17% OB according to the following formula:

83 pts water and 17 pts active ingredient OB+50 pts dry PVOH. Dry solids=(50+17)/150=44.7%; followed by cooking.

This is added to the pigment dispersion to achieve the results and solids advantage shown in Table 7:

TABLE 7
2/1 Wet OB/Dry PVOH
Invention Pre-Blend
One Addition Process
No Dilution of Blend

| % Solids | Coating | % Solids |
|---|---|---|
| Pigment | % Solids | Advantage |
| 70 | 66.3 | +1.1 |
| 76 | 70.9 | +1.3 |
| 76 | 70.9 | +1.0 |

Wet OB/Dry PVOH

### COMPARATIVE EXAMPLE SERIES C

Following the above, the following maximum solids are achieved:

TABLE 8
3.75/1 Wet OB/Dry PVOH

| | Current Methodology |
|---|---|
| % Solids | Ingredients Added Separately |
| Pigment | Max Coating Solids Possible, % |
| 70% | 64.7% using 25% solids PVOH |
| 76% | 69.1% using 25% solids PVOH |
| 76% | 69.4% using 30% solids PVOH |

### EXAMPLE SERIES 3

PVOH/OB mixture follows the formula below:

83 pts water and 17 pts active ingredient OB+26.7 pts dry PVOH. Dry solids =(26.7+17)/126.7=34.5; followed by cooking. The results are shown in Table 9:

TABLE 9
3.75/1 Wet OB/Dry PVOH
Invention Pre-Blend
One Addition Process
No Dilution of Blend

| % Solids | Coating | % Solids |
|---|---|---|
| Pigment | % Solids | Advantage |
| 70 | 65.8 | +1.1 |
| 76 | 70.4 | +1.3 |
| 76 | 70.4 | +1.0 |

5/1 Wet OB/Dry PVOH

### COMPARATIVE EXAMPLE SERIES D

Similarly, current practice yields the following maximum % solids:

TABLE 10
5/1 Wet OB/Dry PVOH

| | Current Methodology |
|---|---|
| % Solids | Ingredients Added Separately |
| Pigment | Coating Solids, % |
| 70% | 64.4% using 25% solids PVOH |
| 76% | 68.7% using 24% solids PVOH |
| 76% | 69.0% using 30% solids PVOH |

### EXAMPLE SERIES 4

The OB/PVOH solution is prepared as follows:

83 pts water and 17 pts active ingredient OB+20 pts dry PVOH. Dry solids=(20+17)/120=30.8%; followed by cooking. The results are shown in Table 11:

TABLE 11
5/1 Wet OB/Dry PVOH
Invention Pre-Blend
One Addition Process
No Dilution of Blend

| % Solids | Coating | % Solids |
|---|---|---|
| Pigment | % Solids | Advantage |
| 70 | 65.5 | +1.1 |
| 76 | 70.0 | +1.3 |
| 76 | 70.0 | +1.0 |

The results for the above Examples are summarized in Table 12 below:

TABLE 12

| Ratio | | | Invention Pre-Blend | | |
|---|---|---|---|---|---|
| OB/PVOH | | | One Addition Process | | |
| Wet pts/Dry | | | No Dilution of Blend | | |
| Pts | | Current Methodology | | | Coating % |
| per 100 pts | % Solids | Ingredients Added Separately | % | Coating % | Solids |
| Pigment | Pigment | Coating Solids, % | Solids | Solids | Advantage |
| 1/1 | 70% | 65.5% using 25% solids PVOH | 58.5 | 66.6 | +1.1 |
| 2/1 | | 65.2% using 25% solids PVOH | 44.7 | 66.3 | +1.1 |
| 3.75/1 | | 64.7% using 25% solids PVOH | 34.4 | 65.8 | +1.1 |
| 5/1 | | 64.4% using 25% solids PVOH | 30.8 | 65.5 | +1.1 |
| 1/1 | 76% | 70.0% using 25% solids PVOH | 58.5 | 71.2 | +1.2 |
| 2/1 | | 69.6% using 25% solids PVOH | 44.7 | 70.9 | +1.3 |
| 3.75/1 | | 69.1% using 25% solids PVOH | 34.4 | 70.4 | +1.3 |
| 5/1 | | 68.7% using 24% solids PVOH | 30.8 | 70.0 | +1.3 |
| 1/1 | 76% | 70.2% using 30% solids PVOH | 58.5 | 71.2 | +1.0 |
| 2/1 | | 69.9% using 30% solids PVOH | 44.7 | 70.9 | +1.0 |
| 3.75/1 | | 69.4% using 30% solids PVOH | 34.4 | 70.4 | +1.0 |
| 5/1 | | 69.0% using 30% solids PVOH | 30.8 | 70.0 | +1.0 |

### EXAMPLE SERIES 5

The above formulations of this invention represent no dilutions in the blend. Viscosities at the 3.75/1 ratio were ˜10,000 cps and at 2/1 greater than 73,000 cps, because of increasing solids. Blends at the 5/1 ratio were ˜4,000-5,000 cps initially through 3 days at 30.8% solids.

It is desirable in some cases to achieve a standard target of 27% total solids by dilution of the inventive formulations. At this level, the viscosity of all of the PVOH/OB concentrates ranged from 2,000-4,000 cps and there was still exhibited a solids advantage over conventional practice, as shown in Table 13 below.

TABLE 13

| Ratio | | | | |
|---|---|---|---|---|
| OB/PVOH | | | | |
| Wet pts/ | Current Methodology | | | |
| Dry | Ingredients Added | Invention Pre-Blend* | | |
| Pts per | Separately | | Coating | |
| 100 pts | Max Coating Solids | Viscosity, | % | % Solids |
| Pigment | Possible, % | cps | Solids | Advantage |
| 1/1 | 65.5% using 25% solids | 2000-4000 | 65.7 | +0.2 |
| | PVOH | | | |
| 2/1 | 65.2% using 25% solids | 2000-4000 | 65.5 | +0.3 |
| | PVOH | | | |
| 3.75/1 | 64.7% using 25% solids | 2000-4000 | 65.3 | +0.6 |
| | PVOH | | | |
| 5/1 | 64.4% using 25% solids | 2000-4000 | 65.2 | +0.8 |
| | PVOH | | | |
| 1/1 | 70.0% using 25% solids | 2000-4000 | 70.2 | +0.2 |
| | PVOH | | | |
| 2/1 | 69.6% using 25% solids | 2000-4000 | 70.0 | +0.4 |
| | PVOH | | | |
| 3.75/1 | 69.1% using 25% solids | 2000-4000 | 69.8 | +0.7 |
| | PVOH | | | |
| 5/1 | 68.7% using 24% solids | 2000-4000 | 69.6 | +0.9 |
| | PVOH | | | |
| 1/1 | 70.2% using 30% solids | 2000-4000 | 70.2 | 0.0 |
| | PVOH | | | |
| 2/1 | 69.9% using 30% solids | 2000-4000 | 70.0 | +0.1 |
| | PVOH | | | |
| 3.75/1 | 69.4% using 30% solids | 2000-4000 | 69.8 | +0.4 |
| | PVOH | | | |
| 5/1 | 69.0% using 30% solids | 2000-4000 | 69.6 | +0.6 |
| | PVOH | | | |

*All formulations diluted to 27% solids

### EXAMPLES 6-10, COMPARATIVE EXAMPLE SERIES E

These examples show that the novel process of this invention does not impair the performance of the optical brightener. The formulation for the paper coatings was as follows:

75/25 dry parts CaCO₃/No. 1 Clay Pigment

14 dry parts styrene-butadiene latex binder

0.3 dry parts carboxymethylcellulose water retention aid

x wet parts OB (TINOPAL® PT)

y dry parts PVOH (CELVOL 203 or 502)

Solids 62%

The formulations were then coated onto paper using a cylindrical coater. Brightness testing results appear in Table 14 below.

The control is the basic liquid-liquid addition sequence of PVOH and OB, whereas Examples 6-10 are in-situ pre-cooked PVOH/OB blends as noted above. Example 6 and the control are both formulated with a 3.75/1 wet OB/dry PVOH. The base paper has a brightness of 84.3 (standard—no UV). After coating, brightness values of the paper (again—no UV) improve to 85.3 and 85.6. The UV brightness measurements show a very significant further improvement to 89.0 and 88.9—comparable to each other. The a* value indicates color shading to either red or green and these would be considered equal to each other. The b* value is important because it indicates the desirable blue-white with negative values and undesirable yellow with positive values. The negative values are desirable and not significant in their differences.

Examples 7 and 8 are formulated at 2/1 with OB/dry PVOH and compare the performance of two PVOH samples with different viscosity values. Both are pre-cooked with OB as per the invention. The significance here is that C-502 performs as well as C-203 and, since it is lower in viscosity, will allow for higher blend solids from 27% to 30% in the optical brightener concentrate for higher coating color solids benefits.

Following the same procedures, Examples 9 and 10 were formulated at 2/1/1 wet OB/dry PVOH/polyethylene glycol 400; except that Example 10 had 2 parts less SBR.

TABLE 14

| | Invention | | | | | | | |
|---|---|---|---|---|---|---|---|---|
| | 27% Solids | | Brightness Testing | | | | | |
| | Wet | Coat | Base | Coated | Coated | | | |
| | OB/dry | Wt. Lbs/ | Paper No | Paper | Paper | UV | | |
| Formulation | PVOH | 3300 ft² | UV | No UV | With UV | Component | a* | b* |
| Base | | | 84.3 | | | | | |
| Comp. | | 7.7 | | 85.3 | 89.0 | +3.7 | +0.02 | −0.37 |
| Ex. E¹ | | | | | | | | |
| EX 6 | 3.75/1 | 7.3 | | 85.6 | 88.9 | +3.3 | −0.03 | −0.45 |
| | (C-203) | | | | | | | |
| EX 7 | 2/1 | 7.8 | | 85.4 | 89.6 | +4.2 | +0.41 | −0.98 |
| | (C-203) | | | | | | | |
| EX 8 | 2/1 (C- | 7.4 | | 85.9 | 89.6 | +3.7 | +0.37 | −1.10 |
| | 502) | | | | | | | |
| EX 9 | 2/1/1 (C- | 7.4 | | 85.7 | 89.7 | +4 | +0.50 | −1.28 |
| | 203) (PEG | | | | | | | |
| | 400) | | | | | | | |
| EX 10 | 2/1/1 (−2 | 7.4 | | 86.2 | 90 | +3.9 | +0.48 | −1.27 |
| | parts SBR) | | | | | | | |

¹3.75/1 OB wet pts/25% C-203 dry pts by separate additions

### EXAMPLES 11, 12 AND COMPARATIVE EXAMPLES F, G

Following the procedures noted above, color coat compositions were prepared with approximately 3/1 and 1/1 wet OB/dry PVOH. The comparative examples had slightly lower solids and were prepared in a conventional manner.

In Table 15, 0.51/1 and 0.17/1 refer to the dry ratios of optical brightener to polyvinyl alcohol and Comparative Examples F and G use a typical optical brightener such as TINOPAL® PT optical brightener with CELVOL® 203 polyvinyl alcohol.

As can be seen from Table 15 below, the inventive concentrates exhibit parity or better in the critical optical measurements of UV Brightness, Blue-White “b” value and CIE Whiteness.

TABLE 15

| | | | | |
|---|---|---|---|---|
| a Value | b Value | CIE White | UV Bright | UV Comp |

0.51/1

| | | | | | |
|---|---|---|---|---|---|
| Comp. Ex. F | 0.74 | 0.3 | 88.4 | 89.5 | 4.3 |
| Example 11 | 1.09 | −0.62 | 92.9 | 91.2 | 5.4 |
| 0.17/1 | | | | | |
| Comp. Ex. G | 0.76 | 0.43 | 88.2 | 89.6 | 3.6 |
| Example 12 | 0.72 | 0.36 | 88.6 | 89.5 | 3.8 |

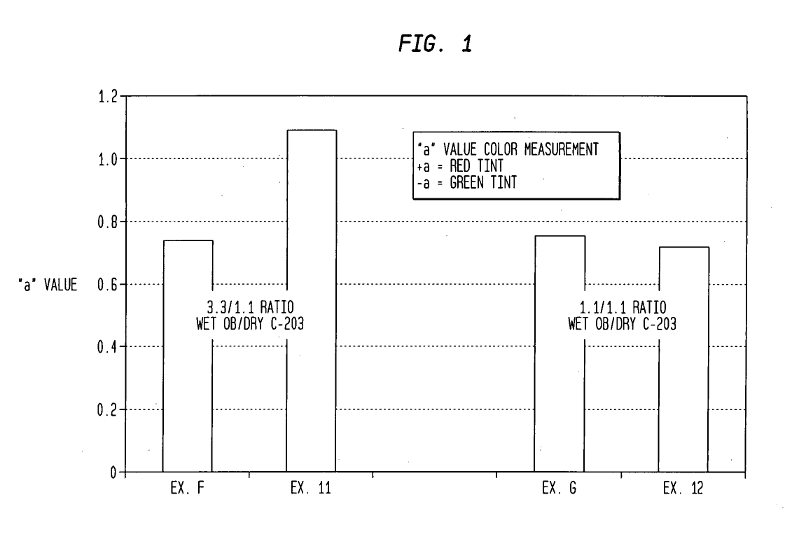

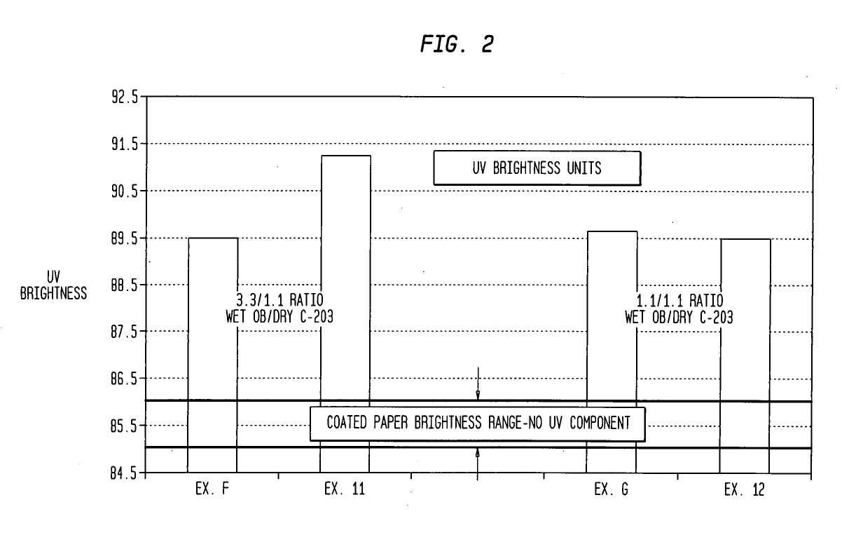

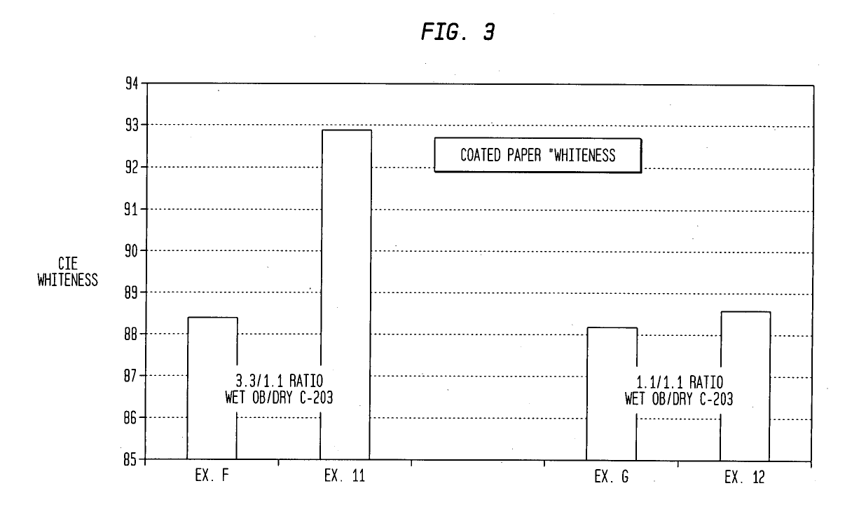

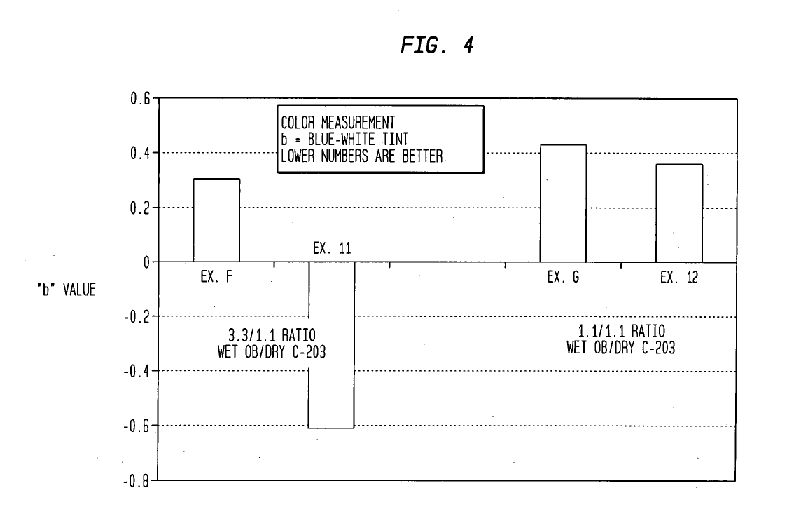

Results are also presented graphically in FIGS. 1-4.

### EXAMPLES 13-16

Additional 3/1 and 1/1 wet OB/dry PVOH concentrates were prepared and blended with a 75% clay/25% calcium carbonate masterbatch as noted in Tables 16-19 below.

TABLE 16
Example 13 Formulation

| | | Total Wet |
|---|---|---|
| Ingredients | Dry Pts | Pts |
| Pigment | 100.00 | 137.36 |
| Latex | 14.00 | 28.00 |
| CMC | .030 | 6.00 |
| 3/1 Concentrate | 0.51/1 | 5.59 |

TABLE 17
Example 14 Formulation

| | | Total Wet |
|---|---|---|
| Ingredients | Dry Pts | Pts |
| Pigment | 100.00 | 137.36 |
| Latex | 14.00 | 28.00 |
| CMC | .030 | 6.00 |
| 1/1 Concentrate | 0.17/1 | 4.33 |

TABLE 18
Example 15 Formulation

| | | Total Wet |
|---|---|---|
| Ingredients | Dry Pts | Pts |
| Pigment | 100.00 | 137.36 |
| Latex | 14.00 | 28.00 |
| CMC | .030 | 6.00 |
| 3/1 Concentrate | 0.51/1 | 5.59 |

TABLE 19
Example 16 Formulation

| | Pigments | Total Wet |
|---|---|---|
| Ingredients | Dry Pts | Pts |
| Pigment | 100.00 | 137.36 |
| Latex | 14.00 | 28.00 |
| CMC | .030 | 6.00 |
| 1/1 Concentrate | 0.17/1 | 4.33 |

Results of optical testing of the coatings on paper appear in Tables 20 and 21 below.

TABLE 20
Coating Properties

| | Coat | | | Brightness | |
|---|---|---|---|---|---|
| | Wt. | Coat Wt. | UV | UV | |
| | (g) | (lb/3300 ft²) | Brightness | excluded | Avg. FL |
| Base Paper | 1.94 | 33.84 | 84.00 | 84.00 | 0.00 |
| Example 13 | 0.51 | 8.90 | 89.68 | 84.86 | 4.82 |
| | 0.52 | 9.07 | 89.60 | 84.93 | 4.68 |
| | 0.58 | 10.12 | 90.01 | 85.24 | 4.77 |
| Example 14 | 0.57 | 9.94 | 89.02 | 85.64 | 3.38 |
| | 0.59 | 10.29 | 88.97 | 85.59 | 3.38 |
| | 0.56 | 9.77 | 88.67 | 85.32 | 3.35 |
| Example 15 | 0.57 | 9.94 | 90.19 | 85.11 | 5.08 |
| | 0.59 | 10.29 | 90.07 | 85.18 | 4.89 |
| | 0.49 | 8.55 | 90.12 | 85.25 | 4.86 |
| Example 16 | 0.49 | 8.55 | 88.49 | 85.26 | 3.23 |
| | 0.49 | 8.55 | 88.13 | 85.10 | 3.04 |
| | 0.52 | 9.07 | 88.00 | 85.16 | 2.64 |

TABLE 21
Coating Properties

| | L | a | b | CIE White | CIE Tint |
|---|---|---|---|---|---|
| Example 13 | 95.86 | 0.60 | 0.45 | 87.86 | −1.38 |
| | 95.86 | 0.99 | 0.20 | 89.02 | −1.89 |
| | 95.93 | 1.10 | 0.16 | 89.35 | −2.05 |
| Example 14 | 96.04 | 0.74 | 0.85 | 86.49 | −1.85 |
| | 95.94 | 0.75 | 0.74 | 86.75 | −1.80 |
| | 95.95 | 0.62 | 1.01 | 85.56 | −1.74 |
| Example 15 | 95.78 | 1.19 | −0.31 | 91.15 | −1.92 |
| | 95.92 | 0.95 | −0.07 | 90.39 | −1.65 |
| | 95.95 | 1.23 | 0.01 | 90.03 | −2.19 |
| Example 16 | 95.95 | 0.73 | 0.95 | 85.81 | −1.90 |
| | 96.00 | 0.49 | 1.26 | 84.51 | −1.68 |
| | 95.91 | 0.43 | 1.43 | 83.55 | −1.68 |

### EXAMPLES 17, 18 COMPARATIVE EXAMPLES H-M

Following generally the procedures noted above, color coat compositions were prepared by substantially conventional techniques (Examples H-M) and by way of adding dry OB powder followed by cooking in-situ in accordance with the invention (Examples 17, 18).

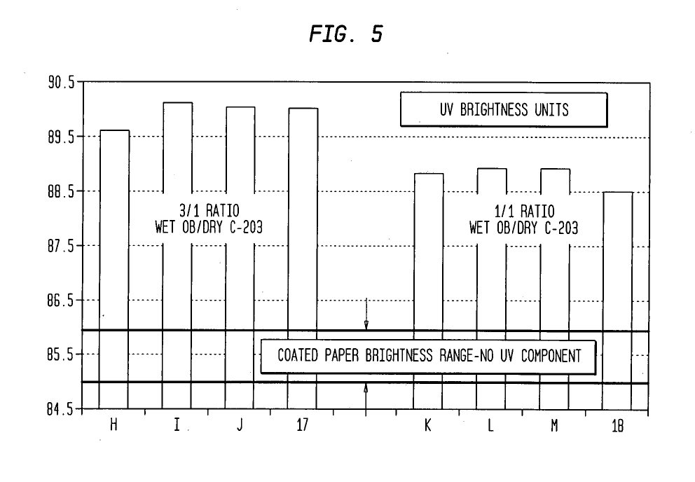

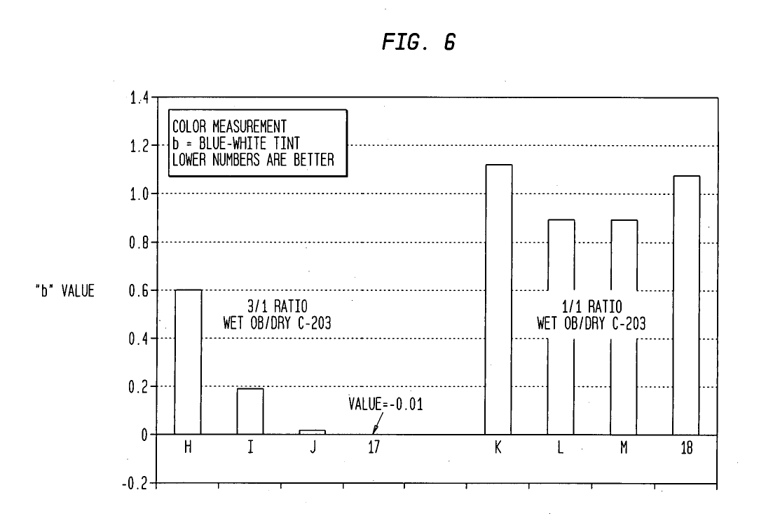

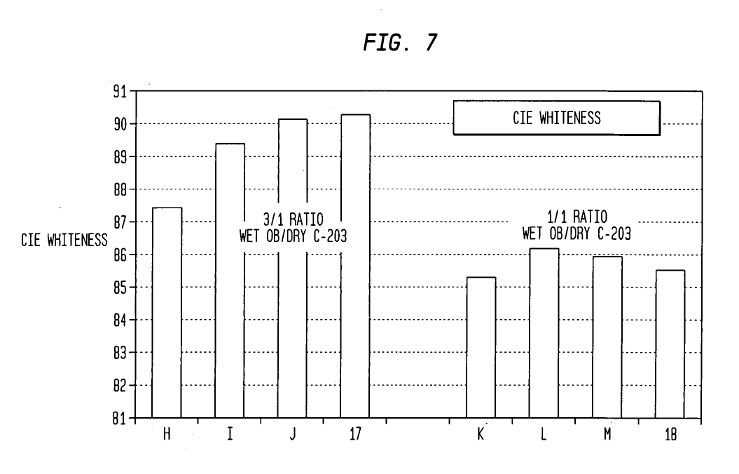

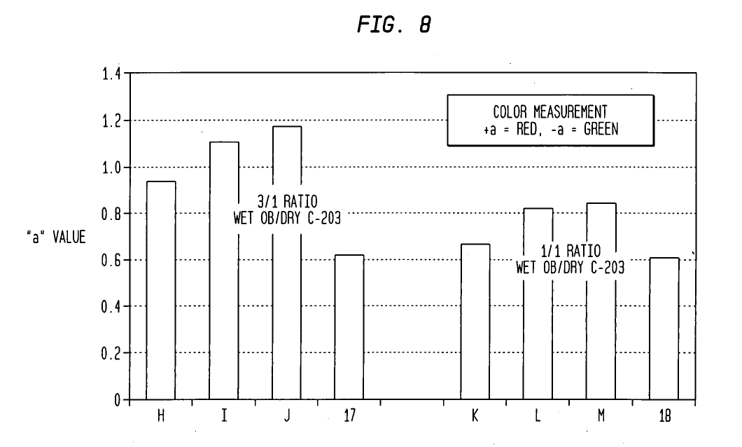

Results appear in Table 22 below as well as FIGS. 5-8.

TABLE 22
Optical Properties

| | | | | | |
|---|---|---|---|---|---|
| Ratio EX | a Value | b Value | CIE White | UV Bright | UV Comp |

3/1

| | | | | | |
|---|---|---|---|---|---|
| Control H | 0.94 | 0.6 | 897.4 | 89.6 | 4.6 |
| PP/203 | 1.11 | 0.19 | 89.4 | 90.1 | 4.5 |
| Dry Add I | | | | | |
| PP/203 | 1.18 | 0.01 | 90.1 | 90 | 4.8 |
| Water Sln J | | | | | |
| PP/203 | 0.61 | −0.01 | 90.3 | 90 | 4.7 |
| Cook w/203 | | | | | |
| Ex 17 | | | | | |
| 1/1 | | | | | |
| Control K | 0.66 | 1.12 | 85.2 | 88.8 | 3.3 |
| PP/203 | 0.86 | 0.89 | 86.1 | 88.9 | 3.1 |
| Dry Add L | | | | | |
| PP/203 | 0.85 | 0.89 | 85.9 | 88.9 | 3.2 |
| Water Sin M | | | | | |
| PP/203 | 0.61 | 1.08 | 85.5 | 88.5 | 3 |
| Cook w/203 | | | | | |
| EX. 18 | | | | | |

### EXAMPLES 19, 20

The following are dry blends and solutions produced in accordance with the invention.

PVOH/OB Aqueous Concentrate with 3:1 Wet/Dry Ratio

Dry PVOH (10 grams) is added to dry OB (5.1 grams) and the resultant mixture is dry blended to produce a uniform mixture of the two ingredients. The dry blend is then slowly added to 40 ml of water. The resulting slurry is heated at a temperature of 200-210° F., with stirring, for a period of 30 minutes to fully dissolve the dry ingredients. The resulting solution is cooled to room temperature to produce a 27.4% solids PVOH/OB concentrate. This example has an OB/PVOH ratio equivalent to a solution of 3 wet parts of optical brightener@ 17% solids to 1 dry part polyvinyl alcohol resin.

PVOH/OB Aqueous Concentrate With 1:1 Wet/Dry Ratio

Dry PVOH (20 grams) is added to dry OB (3.4 grams) and the resultant mixture is dry blended to produce a uniform mixture of the two ingredients. The dry blend is then slowly added to 50 ml of water. The resulting slurry is heated at a temperature of 200-210° F., with stirring, for a period of 30 minutes to fully dissolve the dry ingredients. The resulting solution is cooled to room temperature to produce a 31.9% solids PVOH/OB concentrate. This example has an OB/PVOH ratio equivalent to a solution of 1 wet part of optical brightener@ 17% solids to 1 dry part of polyvinyl alcohol resin.

A dry mixture of PVOH/optical Brightener powder can be added directly to a pigment dispersion while preparing a color coat composition if so desired. A preferred embodiment utilizes PVOH resin having a particle size of less than about 200 microns, that is, 99′% by weight of the resin particles pass through an 80 mesh sieve. This composition can be readily dissolved in the coating slurry during mixing with applied shear in the absence of external heating.

While the invention has been described in connection with several examples, modifications to those examples within the spirit and scope of the invention will be readily apparent to those of skill in the art. In view of the foregoing discussion, relevant knowledge in the art and references including co-pending applications discussed above in connection with the Background and Detailed Description, the disclosures of which are all incorporated herein by reference, further description is deemed unnecessary.

1. In a method of preparing an aqueous composition including an optical brightener and a polyvinyl alcohol resin, the improvement comprising cooking a slurry to dissolve polyvinyl alcohol resin subsequent to the addition of optical brightener and polyvinyl alcohol resin to the slurry at a temperature above about 160° F. for at least about 5 minutes.

2. The improvement according to claim 1, wherein the optical brightener is added to the slurry in substantially dry form.

3. The improvement according to claim 1, wherein the polyvinyl alcohol resin is added to an optical brightener solution in substantially dry form in order to form the slurry.

4. The improvement according to claim 1, wherein both the optical brightener and the polyvinyl alcohol resin are added in substantially dry form.

5. The improvement according to claim 1, wherein the slurry is cooked at a temperature of at least about 175° F. for at least 10 minutes subsequent to the addition of optical brightener and polyvinyl alcohol resin to the slurry.

6. The improvement according to claim 1, wherein the slurry is cooked at a temperature above about 160° F. for at least bout 10 minutes subsequent to the addition of polyvinyl alcohol resin and optical brightener and polyvinyl alcohol resin to the slurry.

7. The improvement according to claim 1, wherein the slurry is cooked at a temperature above about 160° F. for at least bout 20 minutes subsequent to the addition of polyvinyl alcohol resin and optical brightener and polyvinyl alcohol resin to the slurry.

8. The improvement according to claim 1, wherein the slurry is cooked at a temperature of from about 175° F. to about 210° F. for a time of from about 10 minutes to about 120 minutes subsequent to the addition of polyvinyl alcohol resin and optical brightener to the slurry.

9. The improvement according to claim 1, wherein the slurry is cooked at a temperature of from about 185° F. to about 205° F. for a time of from about 20 minutes to about 60 minutes subsequent to the addition of polyvinyl alcohol resin and optical brightener to the slurry.

10. The improvement according to claim 1, wherein the polyvinyl alcohol resin has a viscosity of from about 2 cps to about 40 cps.

11. The improvement according to claim 1, wherein the polyvinyl alcohol resin has a viscosity of from about 2 cps to about 8 cps.

12. The improvement according to Claim b, wherein the polyvinyl alcohol resin has a viscosity of from about 3 cps to about 30 cps.

13. The improvement according to claim 1, wherein the polyvinyl alcohol resin has a viscosity of from about 3 cps to about 8 cps.

14. The improvement according to claim 1, wherein the polyvinyl alcohol resin has a viscosity of from about 3 cps to about 7 cps.

15. The improvement according to claim 1, wherein the polyvinyl alcohol resin is hydrolyzed on a mole percent basis of from about 80 to about 99.5 percent.

16. The improvement according to claim 1, wherein the polyvinyl alcohol resin is hydrolyzed on a mole percent basis of from about 85 percent to about 90 percent.

17. The improvement according to claim 1, wherein the polyvinyl alcohol resin has a degree of polymerization of from about 50 to about 2000.

18. The improvement according to claim 1, wherein the polyvinyl alcohol resin has a degree of polymerization of from about 50 to about 300.

19. The improvement according to claim 1, wherein the optical brightener active ingredient comprises a stilbene compound.

20. The improvement according to claim 19, wherein the stilbene compound is a sulfonated stilbene compound.

21. The improvement according to claim 20, wherein the sulfonated stilbene compound is a tetrasulfonated stilbene compound.

22. The improvement according to claim 21, wherein the sulfonated stilbene compound is a hexasulfonated stilbene compound.

23. The improvement according to claim 1 wherein the optical brightener active ingredient comprises a stilbene compound of the formula: 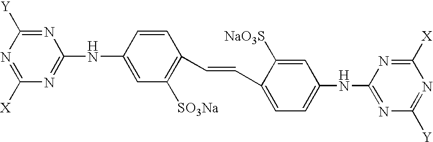
wherein X and Y are independently selected from the moieties indicated below:

24. A method of preparing an optical brightener/PVOH aqueous concentrate comprising the sequential steps of:
a) preparing a PVOH slurry;
b) adding a dry, particulate optical brightener to the PVOH slurry; and
c) cooking the slurry containing PVOH and optical brightener to dissolve the PVOH resin for at least 5 minutes at a temperature of above about 160° F.

25. A method of preparing an optical brightener/PVOH aqueous concentrate comprising the sequential steps of:
a) providing a dry powder optical brightener;
b) providing a dry polyvinyl alcohol resin;
c) dry blending said polyvinyl alcohol resin with said optical brightener in an amount of about 1 part of dry polyvinyl alcohol resin per 0.05 to 1 dry part of optical brightener;
d) admixing said dry blend with water to provide a nascent aqueous concentrate of polyvinyl alcohol resin and optical brightener; and
e) cooking the aqueous concentrate to dissolve the solids at an elevated temperature for a time sufficient to dissolve substantially all of the polyvinyl alcohol resin and optical brightener so as to provide a cooked brightener/polyvinyl alcohol concentrate including water, polyvinyl alcohol resin, optical brightener, and optionally minor amounts of auxiliaries.

26. A method of preparing an color coat composition comprising:
a) preparing an aqueous pigment dispersion;
b) preparing a dry blend of polyvinyl alcohol resin and optical brightener, wherein the polyvinyl alcohol resin is from about 85 mol % to about 90 mol % hydrolyzed and has a fine particle size, such that at least about 99% of the particles pass an 80 mesh sieve;
c) adding the dry blend of polyvinyl alcohol resin and optical brightener to the pigment dispersion; and
d) applying shear to the pigment dispersion containing the polyvinyl alcohol and optical brightener so as to mix the dispersion and dissolve both the optical brightener and polyvinyl alcohol resin without external heating.

27. The method according to claim 26, further comprising adding a latex binder to the pigment dispersion.

28. The method according to claim 26, wherein the pigment dispersion contains a mineral pigment selected from clay, calcium carbonate, titanium dioxide and mixtures thereof.

29. A dry, particulate dry blend of a polyvinyl alcohol resin and an optical brightener.

30. The dry, particulate blend according to claim 29, wherein the polyvinyl alcohol resin is 85-90 mol % hydrolyzed and has a degree of polymerization ranging from about 50 to about 600.

31. The dry, particulate blend according to claim 29, wherein the polyvinyl alcohol resin is 85-90 mol % hydrolyzed and has a degree of polymerization ranging from about 185 to about 235.

32. The dry, particulate blend according to claim 29, wherein the polyvinyl alcohol resin is 87-89 mole % hydrolyzed.

33. The dry, particulate blend according to claim 29, wherein the polyvinyl alcohol resin has a viscosity of from about 2 cps to about 8 cps.

34. The dry, particulate blend according to claim 29, wherein the polyvinyl alcohol resin has a fine particle size such that at least about 99% of the resin passes an 80 mesh sieve.

35. The dry, particulate blend according to claim 29, wherein the polyvinyl alcohol resin has a particle size distribution wherein at least about 99% by weight of the resin particles are less than about 200 microns in size.
